(19) United States
(12) Patent Application Publication
(10) Pub. No.: US 2014/0294306 A1
(43) Pub. Date: Oct. 2, 2014

(54) Apparatus and Non-Transitory Computer-Readable Medium Storing Computer-Readable Instructions

(71) Applicant: Yasuyuki Fujita, Nagoya-shi (JP)

(72) Inventor: Yasuyuki Fujita, Nagoya-shi (JP)

(73) Assignee: BROTHER KOGYO KABUSHIKI KAISHA, Nagoya-shi (JP)

(21) Appl. No.: 14/189,267

(22) Filed: Feb. 25, 2014

(30) Foreign Application Priority Data
Mar. 27, 2013 (JP) 2013-067646

(51) Int. Cl. G06K 9/18

(52) U.S. Cl. CPC G06K 9/18
USPC 382/187

(57) ABSTRACT

An apparatus includes a processor and a memory. The memory is configured to store computer-readable instructions. The computer-readable instructions cause the processor to perform processes that include acquiring detected stroke data indicating a trajectory of a writing portion, determining with reference to a first storage portion, based on the detected stroke data, whether a reference trajectory is included in one of one or more peripheral areas, and each of the one or more peripheral areas being an area surrounding each of one or more reference positions, and correcting the detected stroke data, based on an amount of displacement between the reference trajectory and a reference position that is inside one of the one or more peripheral areas, in a case where it is determined that the reference trajectory is included in the one of the one or more peripheral areas.

### CROSS-REFERENCE TO RELATED APPLICATION

This application claims priority to Japanese Patent Application No. 2013-067646 filed Mar. 27, 2013, the content of which is hereby incorporated herein by reference.

### BACKGROUND

The present disclosure relates to an apparatus that is configured to correct positional displacement of characters etc. caused by positional displacement of a paper medium, and a non-transitory computer-readable medium storing computer-readable instructions.

A correction apparatus is known that is configured to acquire data etc. of characters etc. that are written on a paper medium, and that is configured to correct positional displacement of the characters etc. caused by positional displacement of the paper medium. For example, a known written data input apparatus includes a left-side paper position sensor and a right-side paper position sensor. The left-side paper position sensor may detect a position of a left side corner portion of a paper sheet. The right-side paper position sensor may detect a position of a right side corner portion of the paper sheet. The written data input apparatus may correct input coordinate values that are input at a time of handwriting input, in accordance with an amount of displacement between the positions that are respectively detected by the left-side paper position sensor and the right-side paper position sensor and correct alignment positions of the paper sheet.

### SUMMARY

The above-described known written data input apparatus needs the right-side paper position sensor and the left-side paper position sensor to correct the positional displacement of the characters etc., and thus costs may increase.

Embodiments of the broad principles derived herein provide an apparatus that is capable of correcting positional displacement of data such as written characters etc. while reducing costs, and a non-transitory computer-readable medium storing computer-readable instructions.

Embodiments provide an apparatus that includes a processor and a memory. The memory is configured to store computer-readable instructions. The computer-readable instructions cause the processor to perform a process that includes acquiring detected stroke data. The detected stroke data is data that has been detected by a detection portion. The detected stroke data indicates a trajectory of a writing portion. The detection portion is configured to detect the trajectory of the writing portion that is close to the detection portion. The computer-readable instructions further cause the processor to perform a process that includes determining with reference to a first storage portion, based on the detected stroke data that has been acquired, whether a reference trajectory is included in one of one or more peripheral areas. The reference trajectory is at least a part of the trajectory. The first storage portion stores one or more reference positions and the one or more peripheral areas. Each of the one or more reference positions is a position that is a reference for position correction of the trajectory. Each of the one or more peripheral areas is an area surrounding each of the one or more reference positions. The computer-readable instructions further cause the processor to perform a process that includes correcting the detected stroke data, based on an amount of displacement between the reference trajectory and a reference position that is inside one of the one or more peripheral areas, in a case where it is determined that the reference trajectory is included in the one of the one or more peripheral areas.

Embodiments also include a non-transitory computer-readable medium storing computer-readable instructions that, when executed by a processor of an apparatus, instruct the processor to perform processes that include acquiring detected stroke data, the detected stroke data being data that has been detected by a detection portion, the detected stroke data indicating a trajectory of a writing portion, and the detection portion being configured to detect the trajectory of the writing portion that is close to the detection portion, determining with reference to a first storage portion, based on the detected stroke data that has been acquired, whether a reference trajectory is included in one of one or more peripheral areas, the reference trajectory being at least a part of the trajectory, the first storage portion storing one or more reference positions and the one or more peripheral areas, each of the one or more reference positions being a position that is a reference for position correction of the trajectory, and each of the one or more peripheral areas being an area surrounding each of the one or more reference positions, and correcting the detected stroke data, based on an amount of displacement between the reference trajectory and a reference position that is inside one of the one or more peripheral areas, in a case where it is determined that the reference trajectory is included in the one of the one or more peripheral areas.

### BRIEF DESCRIPTION OF THE DRAWINGS

Embodiments will be described below in detail with reference to the accompanying drawings in which:

FIG. 1 is a configuration diagram of a handwriting input system;

FIG. 2 is a diagram showing an electrical configuration of the handwriting input system;

FIG. 3 is a diagram showing an example of a sheet of a paper medium;

FIG. 4 is a diagram showing positions on a sensor board that correspond to coordinate information that is stored in an HDD;

FIG. 5 is a flowchart of first main processing;

FIG. 6 is a diagram showing a state in which the sheet is arranged on the sensor board;

FIG. 7 is a diagram showing an example of an image that is displayed on a display;

FIG. 8 is a flowchart of second main processing;

FIG. 9 is a diagram showing a state in which the sheet is arranged on the sensor board;

FIG. 10 is a diagram showing an example of an image that is displayed on the display;

FIG. 11 is a data configuration diagram of a tag information data table; and

FIG. 12 is a diagram showing patterns and a pattern obtained by correcting shapes of the patterns.

### DETAILED DESCRIPTION

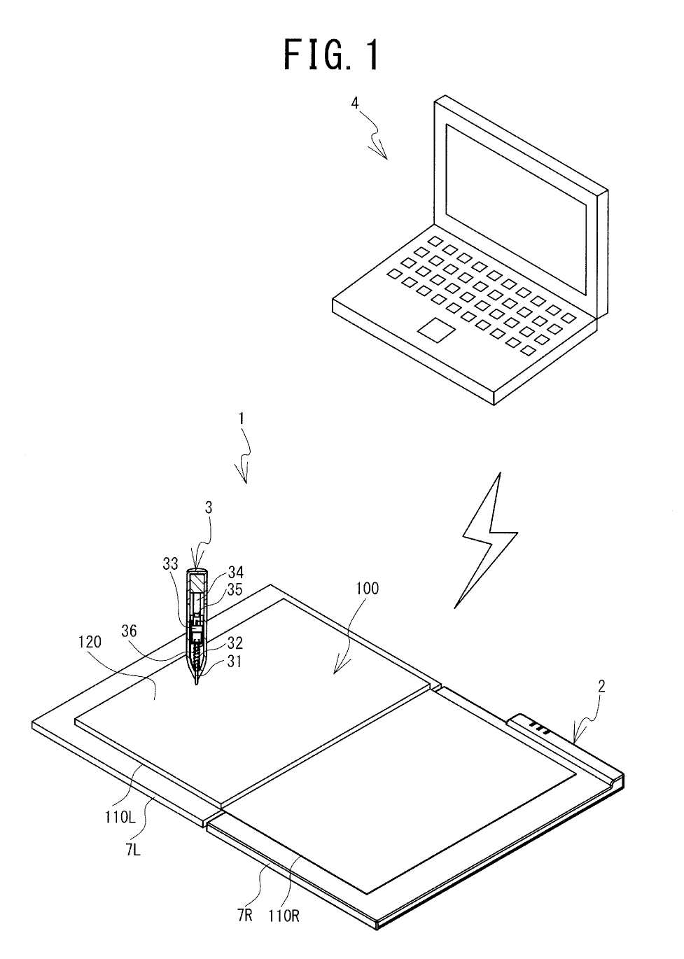

Hereinafter, embodiments will be explained with reference to the drawings. An overview of a handwriting input system 1 according to a first embodiment will be explained with reference to FIG. 1. In the following explanation, an upper left side, a lower right side, an upper side, a lower side, an upper right side, and a lower left side of FIG. 1 respectively define a left side, a right side, an upper side, a lower side, a rear side, and a front side of a reading device 2.

The handwriting input system 1 includes the reading device 2, an electronic pen 3, and a PC 4. In the handwriting input system 1, a user may use the electronic pen 3 to write information by writing a text (a character, a numeral, a symbol, a graphic, etc.) on a paper medium 100 that is fixed to the reading device 2. The reading device 2 may detect a trajectory of the electronic pen 3 that writes the information on the paper medium 100, and may acquire stroke data that will be explained below. Based on the stroke data acquired by the reading device 2, the PC 4 may generate data etc. obtained by digitizing the information written on the paper medium 100.

The reading device 2 mainly includes a pair of left and right sensor boards 7L and 7R. The sensor boards 7L and 7R are the same rectangular thin plate-shaped boards. The sensor boards 7L and 7R can be opened out to a two-page spread in the left-right direction. Each of the sensor boards 7L and 7R is provided with a plurality of long thin loop coils that are arranged in both an X axis direction and in a Y axis direction. The reading device 2 is a thin, light-weight handwriting input device that is portable when the sensor boards 7L and 7R are in a folded over state.

The electronic pen 3 is a known electromagnetic induction-type electronic pen. The electronic pen 3 includes a core body 31, a coil 32, a variable capacity condenser 33, a board 34, a condenser 35 and an ink storage portion 36. The core body 31 is provided on the leading end portion of the electronic pen 3. The core body 31 is urged toward the leading end of the electronic pen 3 by an elastic member that is not shown in the drawings. The leading end portion of the core body 31 protrudes to the outside of the electronic pen 3. The rear end of the core body 31 is connected to the ink storage portion 36. Ink is stored in the ink storage portion 36. The ink storage portion 36 supplies ink to the core body 31. When the user writes using the electronic pen 3, the written text is formed by the ink.

In a state in which the coil 32 is wound around the periphery of the ink storage portion 36, the coil 32 is held between the core body 31 and the variable capacity condenser 33. The variable capacity condenser 33 is fixed to the inside of the electronic pen 3 by the board 34. The condenser 35 is mounted on the board 34. The condenser 35 and the variable capacity condenser 33 are connected in parallel to the coil 32 and form a known resonance (tuning) circuit.

The paper medium 100 has a notebook form that can be opened out to a two-page spread in the left-right direction. In the paper medium 100, a pair of cover sheets (a front cover sheet 110L and a back cover sheet 110R) and a plurality of paper sheets 120 are respectively bound by a part of their edges. As an example, the paper medium 100 is an A5-sized notebook. The paper medium 100 may be mounted on the reading device 2 such that the front cover sheet 110L is placed on the upper surface of the sensor board 7L and the back cover sheet 110R is placed on the upper surface of the sensor board 7R. The user may use the electronic pen 3 to write information on the paper sheet 120 when the paper medium 100 is mounted on the reading device 2. Position information of the electronic pen 3 that writes the information on the paper medium 100 may be detected by one of the sensor boards 7L and 7R that face the paper sheet 120 on which the information has been written.

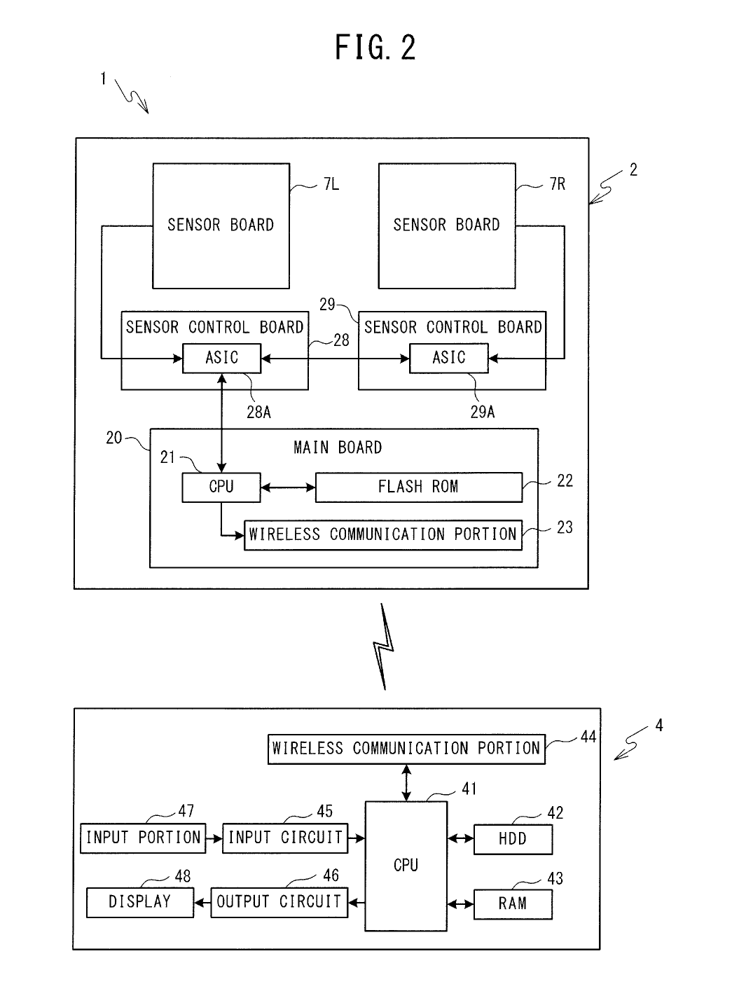

An electrical configuration of the handwriting input system 1 will be explained with reference to FIG. 2. First, an electrical configuration of the reading device 2 will be explained. The reading device 2 includes the sensor boards 7L and 7R, a main board 20, and sensor control boards 28 and 29.

The main board 20 includes a CPU 21, a flash ROM 22, and a wireless communication portion 23. The flash ROM 22 and the wireless communication portion 23 are electrically connected to the CPU 21. The CPU 21 controls the reading device 2. The flash ROM 22 stores various programs that are executed in order for the CPU 21 to control the reading device 2. The flash ROM 22 also stores data that represents the trajectory of the electronic pen 3 that writes the information on the paper medium 100 on the sensor boards 7L and 7R. The data that represents the trajectory of the electronic pen 3 that writes the information on the paper medium 100 on the sensor boards 7L and 7R is hereinafter referred to as stroke data. The stroke data represents the trajectory of the electronic pen 3 that writes the information on the paper medium 100, using information of a plurality of positions of the electronic pen 3 that are detected over time by the sensor boards 7L and 7R. The stroke data includes coordinate information that represents each of a plurality of positions on the trajectory of the electronic pen 3. The wireless communication portion 23 is a controller that is used to execute near-field wireless communication with an external electronic device.

The sensor board 7L is electrically connected to an application-specific integrated circuit (ASIC) 28A of the sensor control board 28. The ASIC 28A performs processing to generate the stroke data based on a writing operation when the writing operation by the electronic pen 3 is performed on the sensor board 7L. This will be explained in more detail below. The sensor board 7R is electrically connected to an ASIC 29A of the sensor control board 29. The ASIC 29A performs processing to generate the stroke data based on a writing operation when the writing operation by the electronic pen 3 is performed on the sensor board 7R. This will be explained in more detail below. The ASIC 28A on the master side is directly connected to the CPU 21. The ASIC 29A on the slave side is connected to the CPU 21 via the ASIC 28A.

The principle of acquiring the stroke data in a case where the writing operation is performed on the sensor boards 7L and 7R by the electronic pen 3 will be briefly explained. The CPU 21 controls the ASIC 28A and the ASIC 29A and causes a current (a transmission current for excitation) of a specific frequency to flow to each one of the loop coils of the sensor boards 7L and 7R. In this way, a magnetic field is generated from each of the loop coils of the sensor boards 7L and 7R. For example, if the user uses the electronic pen 3 to write the information on the paper medium 100 that is fixed to the reading device 2 in this state, the electronic pen 3 comes very close to one of the sensor boards 7L and 7R. Thus, a resonance circuit of the electronic pen 3 resonates as a result of electromagnetic induction and an induction field is generated.

Next, the CPU 21 controls the ASIC 28A and the ASIC 29A and stops the generation of the magnetic field from the loop coils of each of the sensor boards 7L and 7R. Further, the induction field generated from the resonance circuit of the electronic pen 3 is received by the loop coils of each of the sensor boards 7L and 7R. The CPU 21 controls the ASIC 28A and the ASIC 29A and causes a signal current (a reception current) that is flowing through each of the loop coils of the sensor boards 7L and 7R to be detected. The ASIC 28A and the ASIC 29A perform this operation one by one for all of the loop coils, and the position of the electronic pen 3 is detected as coordinate information based on the reception current.

When the user is using the electronic pen 3 to write the information on the paper medium 100, a writing pressure is applied to the core body 31. The inductance of the coil 32 varies depending on the writing pressure applied to the core body 31. In this way, the resonance frequency of the resonance circuit of the electronic pen 3 changes. The CPU 21 detects the change in the resonance frequency (a phase change) and identifies the writing pressure applied to the electronic pen 3. More specifically, the CPU 21 can determine whether or not the information is being written on the paper medium 100 by the identified writing pressure from the electronic pen 3. In a case where the CPU 21 determines that the information is being written on the paper medium 100, the CPU 21 acquires the stroke data that includes the coordinate information representing the position of the electronic pen 3, and stores the acquired stroke data in the flash ROM 22.

The reading device 2 may detect the position of the electronic pen 3 using another method. For example, the reading device 2 may be provided with a touch panel. It is preferable that the driving method of the touch panel be a resistive membrane type. The paper medium 100 may be placed on top of the touch panel. The CPU 21 may detect the position at which the writing pressure is applied from the electronic pen 3 via the touch panel, in a case where the operation of writing the information on the paper medium 100 is performed by the electronic pen 3.

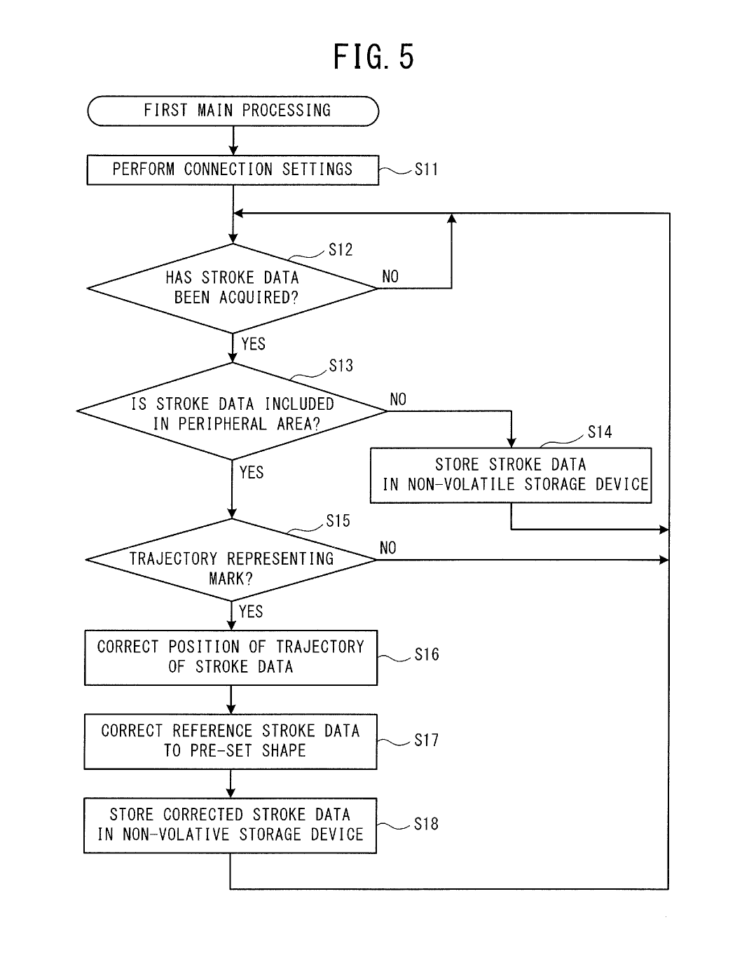

Next, the electrical configuration of the PC 4 will be explained. The PC 4 includes a CPU 41, which controls the PC 4. The CPU 41 is electrically connected to a hard disk drive (HDD) 42, a RAM 43, a wireless communication portion 44, an input circuit 45, and an output circuit 46. The HDD 42 stores various data such as various programs that are executed by the CPU 41. The HDD 42 also stores a correction program, which is used to execute first main processing (refer to FIG. 5) that will be explained below.

The PC 4 includes a medium reading device (a CD-ROM drive, for example) that is not shown in the drawings. The PC 4 can read a correction program that is stored in a storage medium (a CD-ROM, for example) using the medium reading device and can install the correction program in the HDD 42. The correction program may be received from an external device (not shown in the drawings) that is connected to the PC 4 or from a network, and installed in the HDD 42.

The RAM 43 stores a variety of temporary data are stored in the RAM 43. The wireless communication portion 44 is a controller that performs near-field wireless communication with an external electronic device. The input circuit 45 performs control to transmit an instruction to the CPU 41 from an input portion 47 (such as a mouse, a keyboard, a touch panel, or the like). The output circuit 46 performs control to display an image on a display 48 in accordance with an instruction from the CPU 41.

In the present embodiment, the near-field wireless communication can be performed between the wireless communication portion 23 of the reading device 2 and the wireless communication portion 44 of the PC 4. The reading device 2 transmits the stroke data stored in the flash ROM 22 to the PC 4 by the near-field wireless communication. The communication when the stroke data is transmitted from the reading device 2 to the PC 4 is not limited to the wireless communication and wired communication may be used.

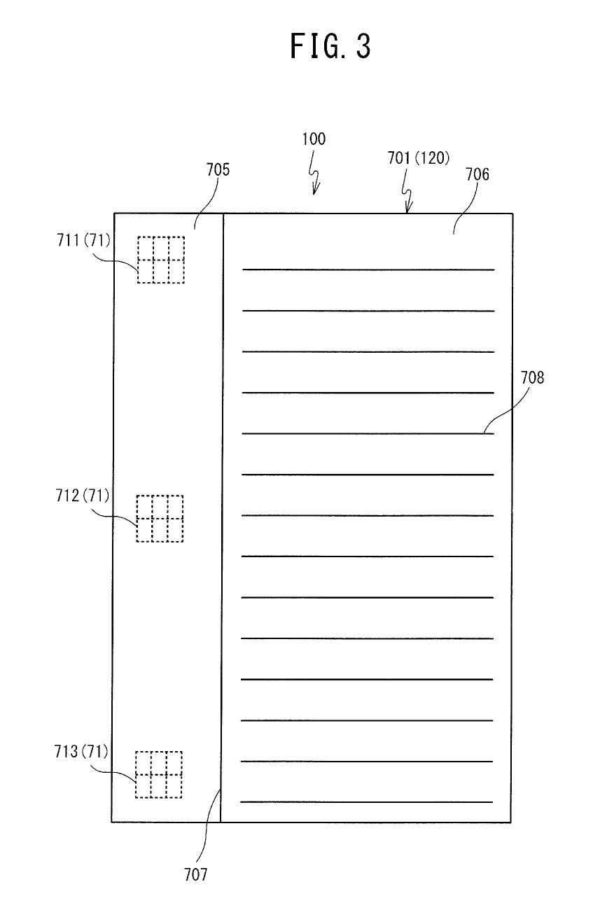

An example of the paper sheet 120 (namely, a paper sheet 701) of the paper medium 100 will be explained with reference to FIG. 3. In the following explanation, the lower side, the upper side, the left side, and the right side in FIG. 3 respectively define the front side, the rear side, the left side, and the right side of the paper sheet 701. The up-down direction, or a direction that is close to the up-down direction, is also referred to as “vertical” and the left-right direction, or a direction that is close to the left-right direction, is also referred to as “horizontal.” The paper sheet 701 is a page of the paper medium 100. An illustration of the other pages of the paper medium 100 is omitted.

As shown in FIG. 3, a mark arrangement area 705 is provided on the left portion of the paper sheet 701. A plurality of marks (three marks, in the present embodiment) 711 to 713 are printed aligned in the up-down direction in the mark arrangement area 705. Each of the marks 711 to 713 has a grid shape that is formed by 4 vertical dotted lines and three horizontal dotted lines. In the following explanation, when the marks 711 to 713 are referred to collectively, or when one of the marks 711 to 713 is not specified, the marks 711 to 713 are referred to as a mark 71 or marks 71.

A writing area 706 is provided to the right of the mark arrangement area 705. A plurality of ruled lines 708 are printed in the writing area 706. A dividing line 707 that runs in the up-down direction is printed between the mark arrangement area 705 and the writing area 706.

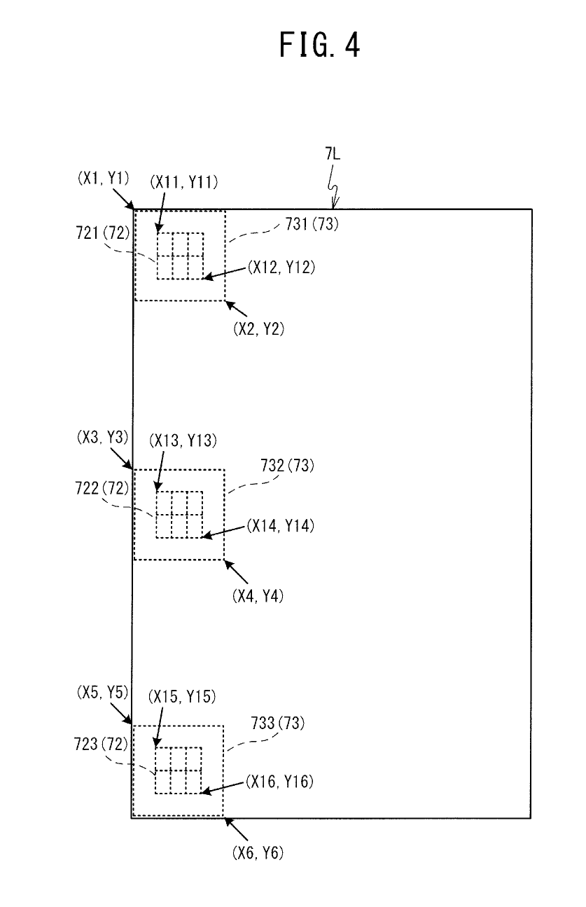

The coordinate information stored in the HDD 42 will be explained with reference to FIG. 4. In the following explanation, the coordinate in the left-right direction in FIG. 4 is the X coordinate and the coordinate in the up-down direction in FIG. 4 is the Y coordinate. The HDD 42 stores reference marks 721 to 723 and peripheral areas 731 to 733. More specifically, the HDD 42 stores, as coordinate information on the sensor board 7L, the reference marks 721 to 723 and the peripheral areas 731 to 733. FIG. 4 illustrates positions on the sensor board 7L that correspond to the reference marks 721 to 723 and the peripheral areas 731 to 733, which are stored as the coordinate information in the HDD 42. FIG. 4 illustrates, of the entire sensor board 7L, only a range corresponding to the paper sheet 701. The HDD 42 also stores reference marks and peripheral areas for the sensor board 7R, similarly to the case of the sensor board 7L, but an explanation thereof is omitted here.

As shown in FIG. 4, the reference marks 721 to 723 are each an aggregate of coordinate information for a grid shape corresponding to each of the marks 711 to 713 (refer to FIG. 3) on the paper sheet 701. FIG. 4 illustrates only upper left coordinate information (X11, Y11) and lower right coordinate information (X12, Y12) for the reference mark 721, but the HDD 42 stores coordinate information of coordinates corresponding to lines of the grid-shaped reference mark 721. In a similar manner to the reference mark 721, the HDD 42 also stores coordinate information of the reference mark 722, which includes upper left coordinate information (X13, Y13) and lower right coordinate information (X14, Y14), and coordinate information of the reference mark 723, which includes upper left coordinate information (X15, Y15) and lower right coordinate information (X16, Y16).

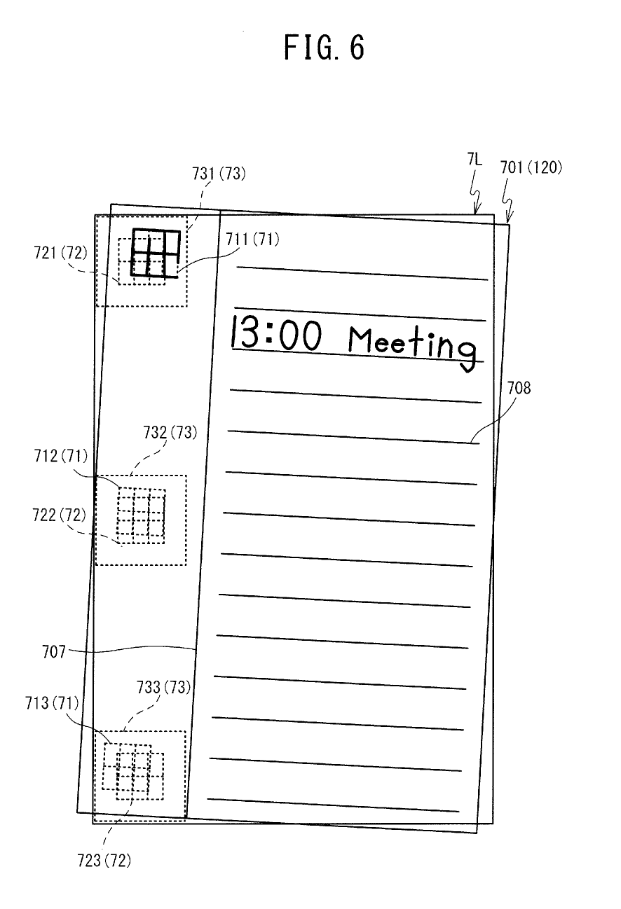

Each of the peripheral areas 731 to 733 is an aggregate of coordinate information of an area surrounding each of the reference marks 721 to 723. FIG. 4 illustrates only upper left coordinate information (X1, Y1) and lower right coordinate information (X2, Y2) for the peripheral area 731, but the HDD 42 stores coordinate information of an area that includes a square external shape and the interior of the square external shape. In a similar manner to the peripheral area 731, the HDD 42 stores coordinate information of the peripheral area 732, which includes upper left coordinate information (X3, Y3) and lower right coordinate information (X4, Y4), and coordinate information of the peripheral area 733, which includes upper left coordinate information (X5, Y5) and lower right coordinate information (X6, Y6). The peripheral area 732 is set in a range in which it is assumed that a trajectory of a line is to be positioned in a case where the user writes the line along the mark 71, even if the paper sheet 701 is arranged such that the paper sheet 701 is tilted with respect to the sensor board 7L (refer to FIG. 6, for example). In the following explanation, when the reference marks 721 to 723 are collectively referred to, or when one of the reference marks 721 to 723 is not specified, the reference marks 721 to 723 are referred to as a reference mark 72 or reference marks 72. When the peripheral areas 731 to 733 are collectively referred to, or when one of the peripheral areas 731 to 733 is not specified, the peripheral areas 731 to 733 are referred to as a peripheral area 73 or peripheral areas 73.

The first main processing will be explained with reference to FIG. 5. The first main processing is processing to correct a position of a trajectory based on the stroke data etc. The user may operate the input portion 47 to input a command to activate an application that executes the first main processing. In this case, the CPU 41 of the PC 4 reads, from the HDD 42, programs to execute the application and expands the programs into the RAM 43. A correction program for the CPU 41 to perform the first main processing is included in the programs to execute the application. The CPU 41 performs the first main processing in accordance with commands of the correction program. The first main processing ends when the input portion 47 is operated and a command is input to end the application that executes the first main processing.

In the following explanation, a specific example is exemplified in which the user writes on the paper sheet 701, as shown in FIG. 6. In the specific example, the user may open the paper medium 100 and may arrange the paper sheet 701 on the sensor board 7L. At this time, it is assumed that the paper sheet 701 is arranged such that the paper sheet 701 is tilted with respect to the sensor board 7L. The user may use the electronic pen 3 to write text in the writing area 706 of the paper sheet 701. After that, the user may use the electronic pen 3 to write a line along the mark 711.

As shown in FIG. 5, in the first main processing, connection settings are performed with the CPU 21 of the reading device 2 via the wireless communication portions 23 and 44, and a state is set in which communication between the CPU 21 of the reading device 2 and the CPU 41 of the PC 4 is possible (step S11). Next, it is determined whether or not the stroke data has been acquired (step S12). If the stroke data has not been acquired (no at step S12), the processing at step S12 is repeated.

The CPU 21 of the reading device 2 acquires the stroke data while the writing is being performed on the paper sheet 701. The CPU 21 transmits the acquired stroke data to the CPU 41 of the PC 4. If the CPU 41 has received the transmitted stroke data (yes at step S12), the CPU 41 refers to the peripheral areas 73 stored in the HDD 42 and determines whether or not the stroke data acquired at step S12 is included in one of the peripheral areas 73 (step S13). More specifically, the CPU 41 determines whether or not the trajectory of the electronic pen 3 represented by the stroke data is included in one of the peripheral areas 73. If the stroke data is not included in any of the peripheral areas 73 (no at step S13), the stroke data is stored in the HDD 42, which is a non-volatile storage device (step S14). The CPU 41 then returns the processing to step S12.

In the specific example, as shown in FIG. 6, the text “13:00 Meeting” is written in the writing area 706. In this case, the stroke data corresponding to the written text is acquired (yes at step S12). It is then determined that the stroke data is not included in any of the peripheral areas 73 (no at step S13) and the stroke data of the trajectory of the text “13:00 Meeting” is stored in the HDD 42 (step S14).

At step S13, if it is determined that the stroke data is included in one of the peripheral areas 73 (yes at step S13), it is determined whether or not the trajectory based on the stroke data that is determined to be included in one of the peripheral areas 73 is the trajectory representing the mark 71 (step S15). If the trajectory based on the stroke data is not the trajectory representing the mark 71 (no at step S15), the CPU 41 returns the processing to step S12.

In the specific example, as shown in FIG. 6, after writing the text “13:00 Meeting” using the electronic pen 3, the user may write the line along the mark 711. At step S15, as an example, it is assumed that it is determined that the trajectory based on the stroke data is the trajectory representing the mark 711 in a case where the three horizontal lines and the four vertical lines are written. As the paper sheet 701 is tilted with respect to the sensor board 7L, the three horizontal lines and the four vertical lines are also tilted.

In a case where the user starts to write the line along the mark 711 from the first line, it is determined that the stroke data is included in the peripheral area 73 (yes at step S13). However, while the three horizontal lines and the four vertical lines are not yet written, the trajectory based on the stroke data is determined not to be the trajectory representing the mark 711 (no at step S15). Then, the CPU 41 repeats the processing at steps S12, S13, and S15. Although not shown in the drawings, the stroke data included in the peripheral area 73 is temporarily stored in the RAM 43. Then, as shown in FIG. 6, in a case where the three horizontal lines and the four vertical lines are written, the trajectory based on the stroke data is determined to be the trajectory representing the mark 711 (yes at step S15). The trajectory representing the mark 711 is the trajectory written by the user using the electronic pen 3. Thus, in the trajectory representing the mark 711, some of the lines may be short or the angle of the lines may be displaced from the mark 71, as shown in FIG. 6.

Next, if the trajectory based on the stroke data is the trajectory representing the mark 71 (yes at step S15), the position of the trajectory of the stroke data acquired at step S12 is corrected based on the trajectory of the stroke data included in the peripheral area 73 and on the amount of displacement of the position of the reference mark 72 that is stored in the HDD 42 (step S16).

In the following explanation, the stroke data that is included in the peripheral area 73 will be referred to as reference stroke data. At step S16, as an example, the position of the trajectory of the stroke data is corrected in the following manner. First, the CPU 41 calculates an angle displacement amount between each of the four vertical lines of the trajectory represented by the reference stroke data (the trajectory along the mark 711) and each of the four vertical lines of the reference mark 721 stored in the HDD 42. The CPU 41 then calculates an average value of the four angle displacement amounts. The CPU 41 tilts the trajectory represented by the reference stroke data by the calculated average value of the angle displacement amounts. In this way, the tilt of the trajectory represented by the reference stroke data is close to the tilt of the reference mark 72. Additionally, the CPU 41 moves the trajectory represented by the reference stroke data such that a displacement amount between the three horizontal lines and the four vertical lines of the reference mark 721 and the three horizontal lines and the four vertical lines of the trajectory represented by the reference stroke data is close to zero. More specifically, the CPU 41 moves the trajectory represented by the reference stroke data to a position in which as many as possible of points (coordinates) represented by the coordinate information of the three horizontal lines and the four vertical lines of the reference mark 72 are in the same position as points (coordinates) represented by the coordinate information of the three horizontal lines and the four vertical lines of the trajectory represented by the reference stroke data. In this manner, the position of the trajectory represented by the reference stroke data comes close to the position of the reference mark 72. The CPU 41 also tilts the trajectory of the stroke data based on the text written in the writing area 706 by the same angle of tilt of the trajectory represented by the reference stroke data, and moves the trajectory of the stroke data based on the text by the same movement amount. The position of the trajectory of the stroke data acquired at step S12 is corrected in this manner.

Next, the trajectory based on the reference stroke data is corrected to a shape that is set in advance (step S17). In the present embodiment, the shape that is set in advance is assumed to be the shape of the reference mark 72 that is stored in the HDD 42. In this case, the trajectory based on the reference stroke data is corrected to the shape of the reference mark 72. Next, the corrected stroke data is stored in the HDD 42, which is the non-volatile storage device (step S18). The corrected stroke data is the stroke data corrected at step S16 and the reference stroke data corrected at step S17. At step S18, the corrected stroke data may be stored in the HDD 42 as image data that includes the trajectory based on the stroke data. After the processing at step S18, the CPU 41 returns the processing to step S12.

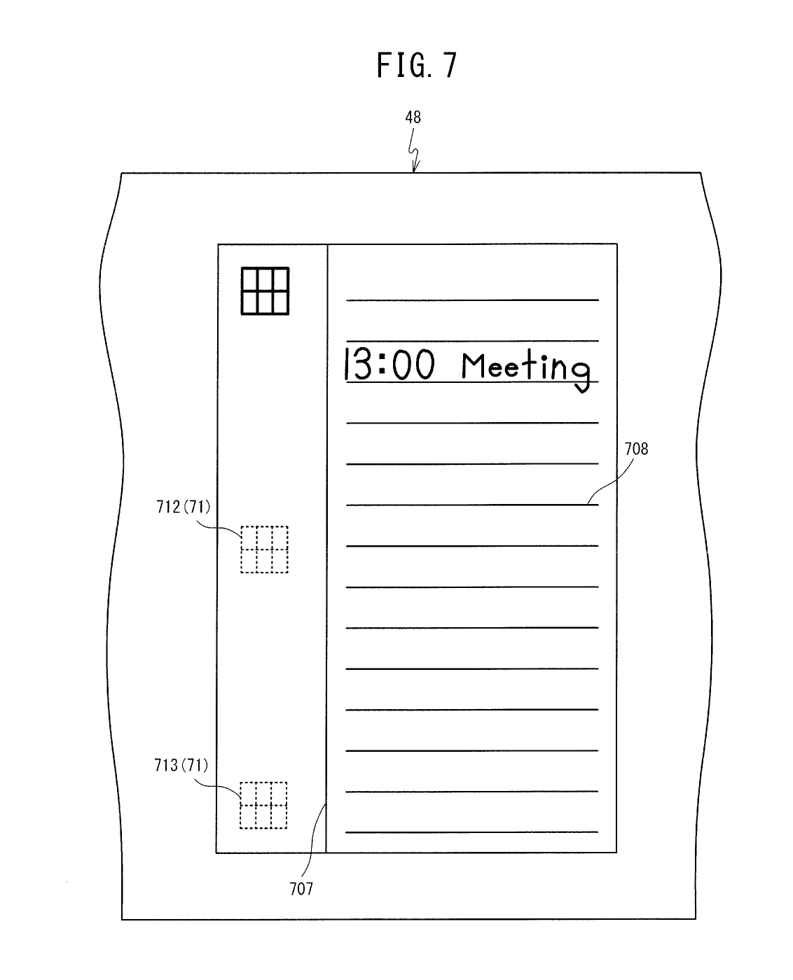

The CPU 41 can display the stroke data stored at step S18 on the display 48. More specifically, the CPU 41 can display the trajectory based on the stroke data stored at step S18 on the display 48. As shown in FIG. 7, for example, the position of the text “13:00 Meeting” that was written on the paper sheet 701 in the tilted state is corrected and the stroke data is displayed on the display 48. In FIG. 6, of the lines indicating the mark 711, some of the lines are short and the angle of some of the lines is displaced from the mark 711. However, the lines indicating the mark 711 are corrected to lines along the mark 711 and displayed. The dividing line 707, the ruled lines 708, and the marks 712 and 713 are not included in the stroke data, but are synthesized with the trajectory based on the stroke data stored at step S18 and are displayed together. The dividing line 707, the ruled lines 708, and the marks 712 and 713 need not necessarily be displayed.

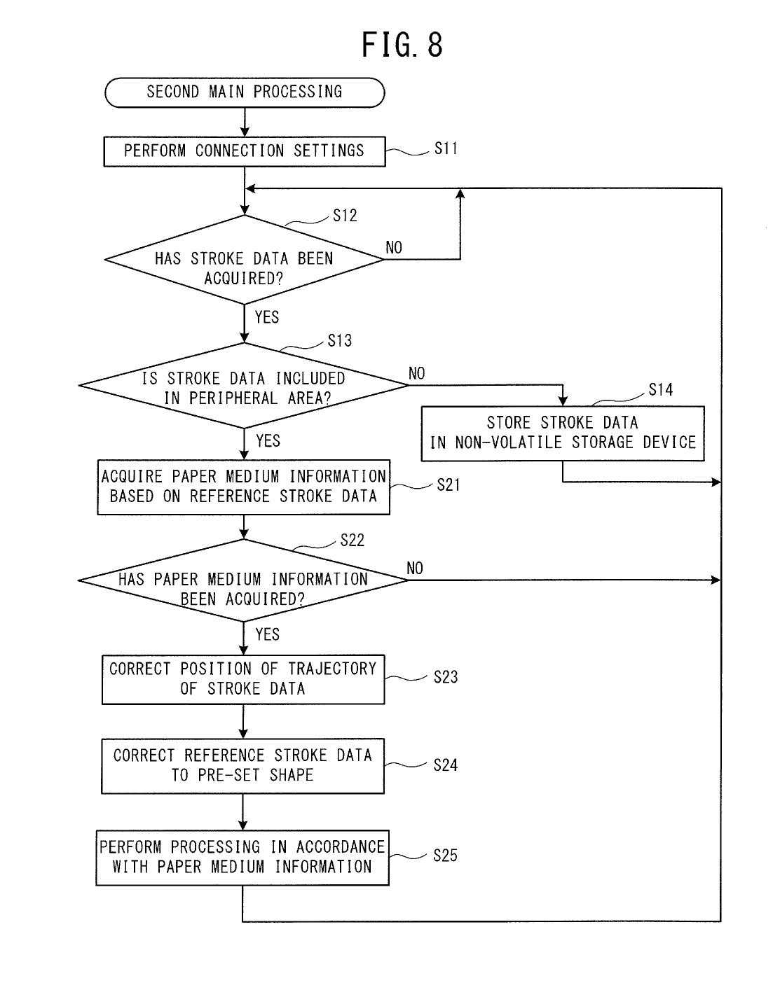

Next, a second embodiment will be explained with reference to FIG. 8. In the second embodiment, second main processing shown in FIG. 8 is performed. In FIG. 8, the same reference numerals are assigned to processing that is the same as that of the first main processing (refer to FIG. 5) of the first embodiment and a detailed explanation thereof is omitted here. In the present embodiment, paper medium information, which is information relating to the paper medium 100, is included in the reference stroke data. The paper medium information of the present embodiment is page information.

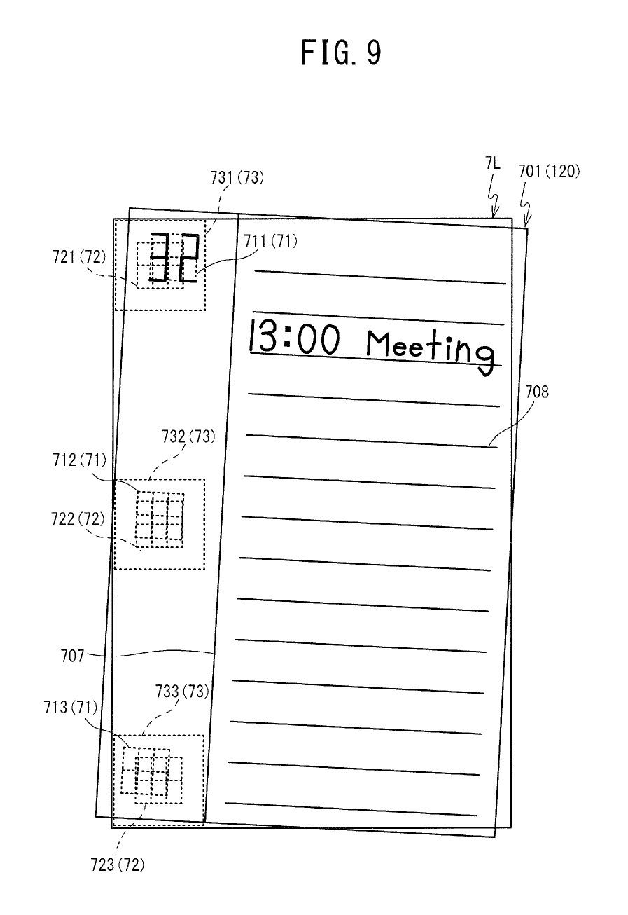

As shown in FIG. 8, in the second main processing, the processing at steps S11 to S14 is performed in a similar manner to the first main processing. In a case where it is determined that the stroke data acquired at step S12 is included in one of the peripheral areas 73 (yes at step S13), the page information, which is the paper medium information, is acquired based on the reference stroke data that is included in the peripheral area 73 (step S21). The acquisition of the page information is performed, for example, by a known pattern matching method and is performed by identifying a numeral that is included in the trajectory based on the reference stroke data. For example, as shown in FIG. 9, when the user writes the page number “32” along the lines of the mark 711 using the electronic pen 3, the page number “32” is acquired based on the reference stroke data of the written numeral“32.”

Next, as a result of the processing at step S21, it is determined whether or not the paper medium information has been acquired (step S22). If the paper medium information has not been acquired (no at step S22), the CPU 41 returns the processing to step S12. If the paper medium information has been acquired (yes at step S22), the position of the trajectory of the stroke data acquired at step S12 is corrected based on the amount of displacement between the trajectory based on the stroke data included in the peripheral area 73 and the position of the reference mark 72 stored in the HDD 42 (step S23).

At step S23, as an example, the position of the trajectory of the stroke data is corrected in the following manner. First, the CPU 41 calculates the angle displacement amount between the vertical lines of the trajectory represented by the reference stroke data and the vertical lines of the reference mark 721 stored in the HDD 42. The CPU 41 then calculates an average value of the angle displacement amounts. The CPU 41 tilts the trajectory represented by the reference stroke data by the calculated average value of the angle displacement amounts. In this way, the tilt of the trajectory represented by the reference stroke data is close to the tilt of the reference mark 721. Additionally, the CPU 41 moves the trajectory represented by the reference stroke data such that a displacement amount between the lines of the numeral of the trajectory represented by the reference stroke data and the three horizontal lines and the four vertical lines of the reference mark 721 is close to zero. More specifically, the CPU 41 moves the trajectory represented by the reference stroke data to a position in which as many as possible of points (coordinates) represented by the coordinate information of the lines of the numeral of the trajectory represented by the reference stroke data are in the same position as points (coordinates) represented by the coordinate information of the three horizontal lines and the four vertical lines of the reference mark 721. In this manner, the position of the trajectory represented by the reference stroke data comes close to the position of the reference mark 721. The CPU 41 also tilts the trajectory of the stroke data based on the text written in the writing area 706 by the same angle of tilt of the trajectory represented by the reference stroke data, and moves the trajectory of the stroke data based on the text by the same movement amount. The position of the trajectory of the stroke data acquired at step S12 is corrected in this manner.

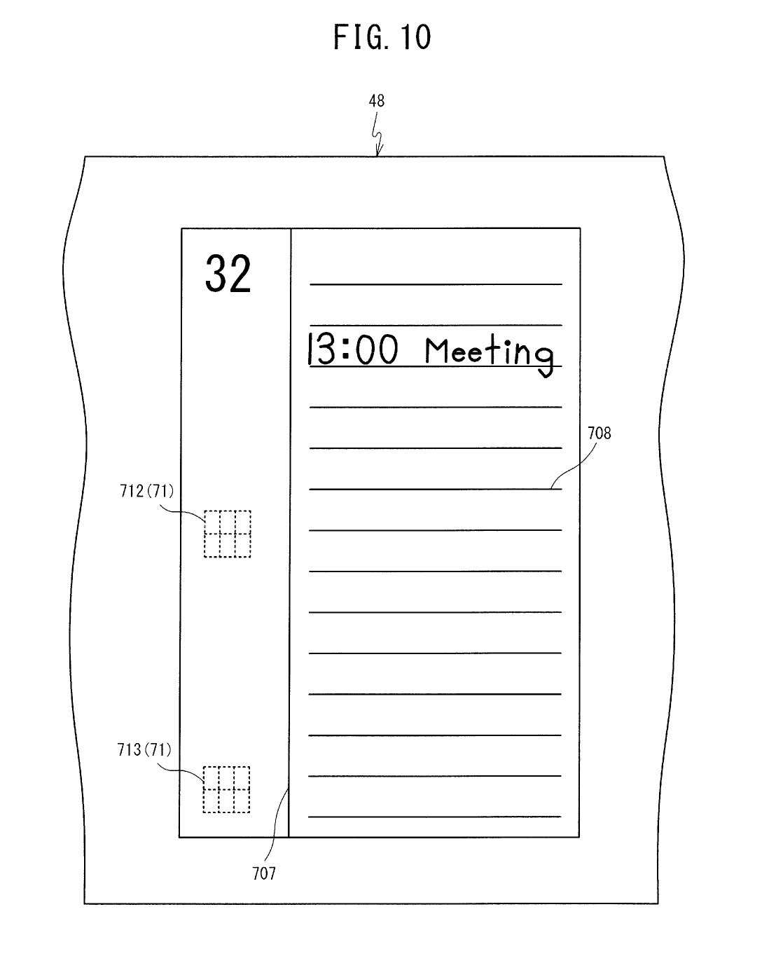

Next, the trajectory based on the reference stroke data is corrected to a shape that is set in advance (step S24). In the present embodiment, the shape that is set in advance is assumed to be a numeral of a predetermined font that is stored in the HDD 42. For example, the numeral “32” that is written in straight lines along the mark 711 as shown in FIG. 9 is corrected to the numeral “32” of the predetermined font, as shown in FIG. 10. Next, processing is performed in accordance with the paper medium information acquired at step S21 (step S25). In the present embodiment, the paper medium information is the page information. At step S25, the page information acquired at step S21 is associated with the stroke data corrected at step S23 and with the stroke data corrected at step S24, and is stored in the non-volatile HDD 42. In this manner, the corrected stroke data is stored as the information of the page “32.”

An image based on the stroke data stored at step S25 is shown in FIG. 10. As shown in FIG. 10, the position of the text “13:00 Meeting” (refer to FIG. 9) that was written on the paper sheet 701 in a tilted state is corrected and displayed. Further, the numeral “32” (refer to FIG. 9) that represents the page information and that is written in straight lines along the mark 711 is corrected to the numeral of the predetermined font.

Next, the CPU 41 returns the processing to step S12, and repeats the processing from step S12 onward. In other words, each time the CPU 41 determines that the stroke data is included in one of the peripheral areas 73 (yes at step S13), the position of the trajectory of the stroke data acquired at step S12 is corrected based on the displacement amount between the position of the trajectory based on the reference stroke data and the position of the reference mark 72 (step S23). Further, each time the CPU 41 determines that the stroke data is included in one of the peripheral areas 73 (yes at step S13), the CPU 41 acquires the page information, which is the paper medium information based on the reference stroke data (step S21). Then, the CPU 41 associates the acquired page information with the corrected stroke data and stores the associated information in the HDD 42 (step S25). Thus, the PC 4 can manage the positionally corrected stroke data page by page.

For example, as shown in FIG. 10, after the stroke data of the text “13:00 Meeting” and the page information “32” are stored at step S25 in the HDD 42, the user may open another page of the paper medium 100. After that, the user may once more open the paper sheet 701 of the page 32 of the paper medium 100. At that time, it is assumed that the paper sheet 701 is tilted with respect to the sensor board 7L. The user may add text using the electronic pen 3 and may write the number “32” on the mark 712, which is the mark 71 that is second from the top. In this case, the CPU 41 acquires the page information that is the paper medium information based on the reference stroke data (step S21). Then, the CPU 41 corrects the stroke data corresponding to the added text (step S23) and corrects the trajectory based on the reference stroke data to the numeral of the predetermined font (step S24). Then, in addition to the stroke data corresponding to the text “13:00 Meeting”, the CPU 41 associates the stroke data corresponding to the corrected added text with the page “32” and stores the associated information (step S25). In this manner, after the user has written on the paper sheet 701, even if the user opens the paper sheet 701 of another page and then once more returns to the original page and writes on the paper sheet 701 again, it is possible to add the corrected stroke data to the page information corresponding to the original page. As a result, convenience for the user may be improved. The page information “32” that is written the second time need not necessarily be displayed on the display 48. The page information “32” may be moved to the center of the lower portion etc. of the paper sheet 701 and displayed on the display 48. The page information “32” need not necessarily be displayed on the display 48.

In the present embodiment, it is possible to correct the position of the trajectory based on the stroke data, based on the reference stroke data included in the stroke data acquired at step S12 (refer to FIG. 5 and FIG. 8) (refer to step S16 in FIG. 5 and step S23 in FIG. 8). As a result, it is not necessary to provide a separate sensor for the purpose of position correction. It is thus possible to reduce costs while correcting positional displacement of the trajectory based on the stroke data that has been written.

The trajectory based on the reference stroke data is corrected to a shape that is set in advance (refer to step S17 in FIG. 5 and step S24 in FIG. 8). As a result, as shown in FIG. 7 and FIG. 10, the corrected trajectory becomes a neater shape than the shape of the trajectory (refer to FIG. 6 and FIG. 9) that is written using the electronic pen 3. Thus, when the trajectory based on the reference stroke data is displayed on the display, the appearance of the displayed trajectory may be improved.

In a case where the user writes along the mark 71, the stroke data of the trajectory along the mark 71 is positioned in the peripheral area 73. Then, the corrected stroke data is automatically stored in the HDD 42, which is the non-volatile storage device (step S18 in FIG. 5 and step S25 in FIG. 8). Therefore, simply by the user writing in the position corresponding to the peripheral area 73, the corrected stroke data is automatically stored in the HDD 42, and thus the convenience for the user may be improved.

The present disclosure is not limited to the above-described embodiments, and various modifications are possible. For example, the method to correct the position of the trajectory of the stroke data at step S16 of the first main processing shown in FIG. 5 and at step S23 of the second main processing shown in FIG. 8 is not limited to the method of the above-described embodiments, and another method may be used. For example, the CPU 41 may correct the position of the trajectory of the stroke data such that the four corners of the external shape of the reference stroke data are aligned with the four corners of the reference mark 72. Further, the method to correct the shape of the trajectory based on the reference stroke data at step S17 of the first main processing and at step S24 of the second main processing is not limited to the method of the above-described embodiments, and another method may be used. The shape of the mark 71 and of the reference mark 72 is not limited to the shape of the above-described embodiment and another shape may be adopted. At step S24 of the second main processing, the trajectory based on the reference stroke data (the numeral) is corrected to the numeral of the predetermined font, but the present disclosure is not limited to this example. For example, the numeral may be corrected to a so-called seven-segment display. The number of each of the marks 71, the reference marks 72, and the peripheral areas 73 is not limited to three. For example, only one mark 71, one reference mark 72 and one peripheral area 73 may be provided, or five of each of the marks 71, the reference marks 72 and the peripheral areas 73 may be provided.

The marks 71 may be provided in the four corners of the paper sheet 701, and the reference marks 72 and the peripheral areas 73 may be provided in positions corresponding to the marks 71 in the four corners. At step S15 of the first main processing shown in FIG. 5, it may be determined that the trajectory based on the stroke data is a trajectory indicating the mark when lines have been written along all of the marks 71 provided in the four corners. In this case, when the correction of the position of the stroke data is performed at step S16, the position of the trajectory of the stroke data may be corrected based on the stroke data of the trajectory written along the marks 71 in the four corners. In this case, as there is a greater number of pieces of reference stroke data used in the correction, the accuracy when correcting the position of the paper sheet 701 is further improved.

At step S18 of the first main processing and step S25 of the second main processing, the CPU 41 need not necessarily store the reference stroke data after correction that has been corrected at step S17 and step S24, respectively. The processing at step S17 and step S24 need not necessarily be performed. The stroke data may be stored in the RAM 43 at steps S14 and S18 of the first main processing and at steps S14 and S25 of the second main processing.

The first main processing and the second main processing need not necessarily be performed by the CPU 41 of the PC 4. For example, the first main processing and the second main processing may be performed by the CPU 21 of the reading device 2. In this case, the various data of the correction program etc. may be stored in the flash ROM 22 in place of the HDD 42 and the RAM 43. Then, at step S18 of the first main processing or at step S25 of the second main processing, the CPU 21 may transmit the corrected stroke data that is stored in the flash ROM 22 to the PC 4. The reading device 2 may be connected to a mobile terminal etc. instead of being connected to the PC 4, and a CPU of the mobile terminal etc. may perform the first main processing and the second main processing.

In the second embodiment, the paper medium information is the page information and the corrected stroke data is associated with the page information and stored (step S25), but the present disclosure is not limited to this example. For example, the paper medium information may be other information, such as date information, tag information, an electronic mail address etc. At this time, the shape of the mark 71, the reference mark 72, and the peripheral area 73 may be a shape that accords with the type of the paper medium information.

In a case where the paper medium information is the date information, the user may write a numeral of the date along the lines of the mark 71 using the electronic pen 3. The CPU 41 may acquire the reference stroke data that accords with the numeral of the date that are written (yes at step S12) and may acquire the date information (step S21). Then, at step S25, the CPU 41 may associate the stroke data corrected at steps S23 and S24 with the date information and may store the associated information in the HDD 42. In this manner, the corrected stroke data may be managed according to the date.

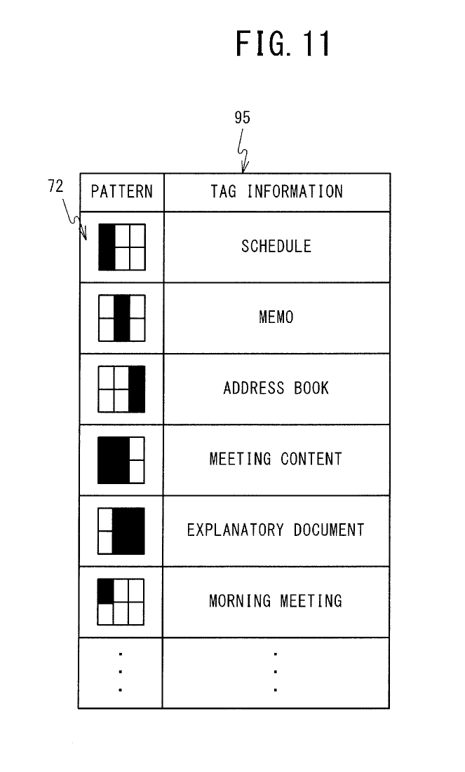

In a case where the paper medium information is the tag information, a tag information data table 95 shown in FIG. 11 may be stored in the HDD 42. Patterns and tag information may be stored in the tag information data table 95 in association with each other. Each of the patterns may be a type of the reference mark 72, and may be a pattern in which at least a part of the area on the inside of the grid-shaped reference mark 72 of the first embodiment is filled in. The tag information may be classification information. The user may operate the PC 4 to associate the desired tag information with the pattern and to store the associated information in the HDD 42. In the tag information data table 95 shown in FIG. 11, schedule, memo, address book, meeting content, explanatory document, and morning meeting etc. are registered as the tag information.

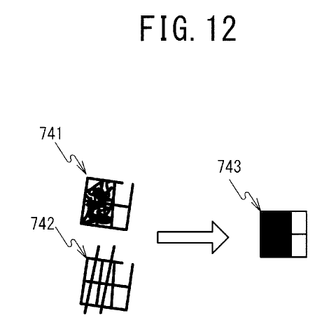

It is assumed that the user uses the electronic pen 3 to write the pattern in the mark 71 and the CPU 41 acquires a pattern 741 or a pattern 742 shown in FIG. 12 as the reference stroke data (yes at step S12 shown in FIG. 8). In a case where the paper medium 100 is tilted with respect to the sensor board 7L, the patterns 741 and 742 are also tilted. The pattern 741 is formed by filling in, using the electronic pen 3, the upper and lower areas of the left side portion and the upper and lower areas of the center portion of the grid-shaped mark 71. The pattern 742 is formed by drawing a line through the upper and lower areas of the left side portion and a line through the upper and lower areas of the center portion of the grid-shaped mark 71. At step S21, the CPU 41 may acquire the tag information, which is the paper medium information, based on the reference stroke data of the pattern 741 or the pattern 742. At that time, the CPU 41 may refer to the tag information data table 95 shown in FIG. 11 and may acquire the tag information “Meeting content”, which corresponds to the pattern in which the upper and lower areas of the left side portion and the upper and lower areas of the center portion of the reference mark 72 are filled in. At step S25, the CPU 41 may associate the tag information “Meeting content” with the stroke data corrected at steps S23 and S24 and may store the associated information. The pattern 743 shown in FIG. 12 may be a pattern shown by the reference stroke data corrected at step S24. The pattern 741 may be the pattern that is drawn by hand by the user, therefore the areas are not accurately filled in, and the lines are also displaced from the mark 71. In the pattern 742, the lines are drawn through the upper and lower areas of the left side portion and through the upper and lower areas of the center portion. However, in the pattern 743 that is corrected at step S24, the angles of the lines may be corrected and the filled in areas or the areas through which the lines are drawn may be accurately filled in.

Although not shown in the drawings, in a case where the paper medium information is the electronic mail address, patterns similar to the patterns shown in FIG. 11 may be associated with electronic mail addresses and may be stored in the HDD 42. Then, similarly to the case in which the paper medium information is the tag information, the electronic mail address corresponding to the pattern may be acquired (step S21). Then, at step S25, the stroke data corrected at steps S23 and S24 may be automatically transmitted to the electronic mail address acquired at step S21.

As in the above-described second embodiment and modified example, in the second main processing, the paper medium information is acquired (step S21) and the processing according to the paper medium information is performed (step S25). Simply by the user writing on the mark 71 in the peripheral area 73, the position of the stroke data is corrected at steps S23 and S24 and the processing according to the paper medium information is performed at step S25. Thus, convenience for the user may be improved.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An apparatus comprising:
a processor; and
a memory configured to store computer-readable instructions, wherein the computer-readable instructions cause the processor to perform processes comprising:
acquiring detected stroke data, the detected stroke data being data that has been detected by a detection portion, the detected stroke data indicating a trajectory of a writing portion, and the detection portion being configured to detect the trajectory of the writing portion that is close to the detection portion;
determining with reference to a first storage portion, based on the detected stroke data that has been acquired, whether a reference trajectory is included in one of one or more peripheral areas, the reference trajectory being at least a part of the trajectory, the first storage portion storing one or more reference positions and the one or more peripheral areas, each of the one or more reference positions being a position that is a reference for position correction of the trajectory, and each of the one or more peripheral areas being an area surrounding each of the one or more reference positions; and
correcting the detected stroke data, based on an amount of displacement between the reference trajectory and a reference position that is inside one of the one or more peripheral areas, in a case where it is determined that the reference trajectory is included in the one of the one or more peripheral areas.

2. The apparatus according to claim 1, wherein
the computer-readable instructions further cause the processor to perform a process comprising:
correcting reference stroke data to obtain data indicating a shape that is set in advance, the reference stroke data being a part of the detected stroke data, and the reference stroke data indicating the reference trajectory that is included in the one of the one or more peripheral areas.

3. The apparatus according to claim 1, wherein
the computer-readable instructions further cause the processor to perform processes comprising:
acquiring paper medium information based on reference stroke data, the paper medium information being information related to a paper medium, the reference stroke data being a part of the detected stroke data, and the reference stroke data indicating the reference trajectory that is included in the one of the one or more peripheral areas; and
performing processing in accordance with the paper medium information that has been acquired.

4. The apparatus according to claim 3, wherein
the paper medium information is page information,
the acquiring the paper medium information includes acquiring the page information based on the reference stroke data, and
the performing the processing in accordance with the paper medium information includes storing, in a second storage portion, the page information that has been acquired and the detected stroke data that has been corrected in association with each other.

5. The apparatus according to claim 4, wherein
the one or more reference positions are a plurality of reference positions,
the one or more peripheral areas are a plurality of peripheral areas,
the first storage portion stores the plurality of reference positions and the plurality of peripheral areas, each of the plurality of peripheral areas being an area surrounding each of the plurality of reference positions,
the determining whether the reference trajectory is included in one of the one or more peripheral areas includes determining with reference to the first storage portion, based on the detected stroke data, whether the reference trajectory is included in one of the plurality of peripheral areas,
the correcting the detected stroke data includes correcting the detected stroke data based on an amount of displacement between the reference trajectory and a reference position that is inside one of the plurality of peripheral areas, each time it is determined that the reference trajectory is included in one of the plurality of peripheral areas, and
the acquiring the paper medium information includes acquiring the page information based on the reference stroke data, each time it is determined that the reference trajectory is included in one of the plurality of peripheral areas.

6. The apparatus according to claim 1, wherein
the computer-readable instructions further cause the processor to perform a process comprising:
storing, in a non-volatile third storage portion, the detected stroke data that has been corrected, in a case where it is determined that the reference trajectory is included in the one of the one or more peripheral areas.

7. The apparatus according to claim 1, wherein
the computer-readable instructions further cause the processor to perform a process comprising:
displaying a trajectory on a display portion based on display stroke data, the display stroke data including, of the detected stroke data that has been corrected, at least data other than reference stroke data that has been corrected, the reference stroke data being a part of the detected stroke data, the reference stroke data indicating the reference trajectory that is included in the one of the one or more peripheral areas, and the display portion being configured to display an image.

8. The apparatus according to claim 2, wherein
the computer-readable instructions further cause the processor to perform a process comprising:
displaying a trajectory that includes the shape on a display portion, based on display stroke data, the display stroke data including the detected stroke data that has been corrected, the detected stroke data that has been corrected including the reference stroke data that has been corrected, and the display portion being configured to display an image.

9. A non-transitory computer-readable medium storing computer-readable instructions that, when executed by a processor of an apparatus, instruct the processor to perform processes comprising:
acquiring detected stroke data, the detected stroke data being data that has been detected by a detection portion, the detected stroke data indicating a trajectory of a writing portion, and the detection portion being configured to detect the trajectory of the writing portion that is close to the detection portion;
determining with reference to a first storage portion, based on the detected stroke data that has been acquired, whether a reference trajectory is included in one of one or more peripheral areas, the reference trajectory being at least a part of the trajectory, the first storage portion storing one or more reference positions and the one or more peripheral areas, each of the one or more reference positions being a position that is a reference for position correction of the trajectory, and each of the one or more peripheral areas being an area surrounding each of the one or more reference positions; and
correcting the detected stroke data, based on an amount of displacement between the reference trajectory and a reference position that is inside one of the one or more peripheral areas, in a case where it is determined that the reference trajectory is included in the one of the one or more peripheral areas.

10. The non-transitory computer-readable medium according to claim 9, wherein
the computer-readable instructions further instruct the processor to perform a process comprising:
correcting reference stroke data to obtain data indicating a shape that is set in advance, the reference stroke data being a part of the detected stroke data, and the reference stroke data indicating the reference trajectory that is included in the one of the one or more peripheral areas.

11. The non-transitory computer-readable medium according to claim 9, wherein
the computer-readable instructions further instruct the processor to perform processes comprising:
acquiring paper medium information based on reference stroke data, the paper medium information being information related to a paper medium, the reference stroke data being a part of the detected stroke data, and the reference stroke data indicating the reference trajectory that is included in the one of the one or more peripheral areas; and
performing processing in accordance with the paper medium information that has been acquired.

12. The non-transitory computer-readable medium according to claim 11, wherein
the paper medium information is page information,
the acquiring the paper medium information includes acquiring the page information based on the reference stroke data, and
the performing the processing in accordance with the paper medium information includes storing, in a second storage portion, the page information that has been acquired and the detected stroke data that has been corrected in association with each other.

13. The non-transitory computer-readable medium according to claim 12, wherein
the one or more reference positions are a plurality of reference positions,
the one or more peripheral areas are a plurality of peripheral areas,
the first storage portion stores the plurality of reference positions and the plurality of peripheral areas, each of the plurality of peripheral areas being an area surrounding each of the plurality of reference positions,
the determining whether the reference trajectory is included in one of the one or more peripheral areas includes determining with reference to the first storage portion, based on the detected stroke data, whether the reference trajectory is included in one of the plurality of peripheral areas,
the correcting the detected stroke data includes correcting the detected stroke data based on an amount of displacement between the reference trajectory and a reference position that is inside one of the plurality of peripheral areas, each time it is determined that the reference trajectory is included in one of the plurality of peripheral areas, and
the acquiring the paper medium information includes acquiring the page information based on the reference stroke data, each time it is determined that the reference trajectory is included in one of the plurality of peripheral areas.

14. The non-transitory computer-readable medium according to claim 9, wherein
the computer-readable instructions further instruct the processor to perform a process comprising:
storing, in a non-volatile third storage portion, the detected stroke data that has been corrected, in a case where it is determined that the reference trajectory is included in the one of the one or more peripheral areas.

15. The non-transitory computer-readable medium according to claim 9, wherein
the computer-readable instructions further instruct the processor to perform a process comprising:
displaying a trajectory on a display portion based on display stroke data, the display stroke data including, of the detected stroke data that has been corrected, at least data other than reference stroke data that has been corrected, the reference stroke data being a part of the detected stroke data, the reference stroke data indicating the reference trajectory that is included in the one of the one or more peripheral areas, and the display portion being configured to display an image.

16. The non-transitory computer-readable medium according to claim 10, wherein
the computer-readable instructions further instruct the processor to perform a process comprising:
displaying a trajectory that includes the shape on a display portion, based on display stroke data, the display stroke data including the detected stroke data that has been corrected, the detected stroke data that has been corrected including the reference stroke data that has been corrected, and the display portion being configured to display an image.
